(19) United States
(12) Patent Application Publication
(10) Pub. No.: US 2014/0377419 A1
(43) Pub. Date: Dec. 25, 2014

(54) MICROWAVE COOKING APPARATUS

(71) Applicants: Kayomars Kadva, Liverpool (AU); Kersi Kadva, Liverpool (AU)

(72) Inventors: Kayomars Kadva, Liverpool (AU); Kersi Kadva, Liverpool (AU)

(21) Appl. No.: 14/359,297

(22) PCT Filed: Oct. 18, 2012
(86) PCT No.: PCT/AU2012/001271

§ 371 Date: May 19, 2014

(30) Foreign Application Priority Data
Nov. 20, 2011 (AU) 2011101504

(51) Int. Cl. H05B 6/64; A21D 8/06

(52) U.S. Cl. CPC H05B 6/6408; A21D 8/06
USPC 426/243; 219/725; 219/732

(57) ABSTRACT

A microwave cooking apparatus (10) is provided for cooking papadums in a microwave oven. The cooking apparatus (10) has a base (12), a plurality of dividers (14) and one or more spacer members (16). The base (12) is adapted to receive a plurality of uncooked papadums arranged in a generally upright orientation relative to an upper surface (18) of the base (12). The dividers (14) are provided on the upper surface (18) of the base (12) and are arranged parallel to one another in a row, so as to receive one papadum between each pair of adjacent dividers (14) in the row. The spacer members (16) project from the dividers (14) and are adapted to keep adjacent papadums in the row spaced from one another.

### FIELD OF THE INVENTION

The present invention relates to microwave cooking and in particular, to an apparatus for cooking papadums in a microwave oven.

### BACKGROUND OF THE INVENTION

A papadum is a thin, crisp Indian flatbread which is typically cooked by deep frying in oil.

However, deep frying in oil significantly raises the fat content of food, which is undesirable because of the health implications of high fat foods.

Alternatively, papadums can be cooked in a microwave oven. Typically, two or three papadums are placed on a large plate, covered with kitchen paper and cooked in the microwave for a short period of time. Papadums cooked in a microwave oven are generally considered to be healthier due to their lower fat content. It is also significantly quicker and more convenient to cook papadums in a microwave oven rather than to cook them in a wok or deep frier filled with oil.

However, papadums cooked in this fashion in a microwave tend to absorb a significant amount of moisture in the cooking process and tend to be softer and flatter than authentic papadums. This is generally undesirable as an authentic fried papadum is typically very crisp and partially curled, particularly at the edges.

Other existing microwave cooking devices are not suitable for holding multiple papadums.

### OBJECT OF THE INVENTION

It is an object of the present invention to substantially overcome or at least ameliorate one or more of the above disadvantages, or to provide a useful alternative.

### SUMMARY OF THE INVENTION

In a first aspect, the present invention provides a microwave cooking apparatus for cooking papadums in a microwave oven, the cooking. apparatus comprising:
a base adapted to receive a plurality of uncooked papadums arranged in a generally upright orientation relative to an upper surface of the base;
a plurality of dividers provided on the upper surface of the base and arranged parallel to one another in a row, the dividers adapted to receive one papadum between each pair of adjacent dividers in the row; and
one or more spacer members projecting from at least one of the dividers, the spacer members being adapted to keep adjacent papadums in the row spaced from one another.

In a preferred embodiment, a ventilation aperture is provided in at least one of the dividers, the ventilation aperture allowing air to circulate between adjacent papadums. Preferably, the ventilation aperture is raised above the upper surface of the base by the divider.

Preferably, the base has at least one support member projecting from a lower surface of the base and wherein, when the cooking apparatus is placed on a support surface, the support member is adapted to support the base such that the lower surface of the base is spaced above the support surface, providing a clearance between the base and the support surface.

Holes are preferably provided in the base between the dividers to allow air to circulate from beneath the base.

In a preferred embodiment, the base has a pair of opposing edge portions, the edge portions curling upwardly from the base along opposite sides of the base, creating a generally U-shaped profile.

Preferably, a ratio of a height of the edge portions above the base to a total width of the base is in the range 1:2 and 1:4. Further preferably, the ratio of the height of the edge portions from the base to the total width of the base is approximately 2:5.

Preferably, the base includes a single row of eleven dividers adapted to accommodate ten spaced papadums.

In a preferred embodiment, each divider has a pair of parallel spacer elements extending upwardly from opposite ends of the divider.

Preferably, the spacer elements are detachable from the dividers. Further preferably, the spacer elements each have a wedge shaped tongue portion and the dividers have corresponding slots, the tongue portion of each spacer element being configured to be received in the corresponding slot and retained in the slot by way of interference fit between the wedge shaped tongue and the slot.

Preferably, a pair of corresponding slots is provided on a pair of respective raised portions projecting upwardly at opposite ends of one or more of the dividers.

In a second aspect, the present invention provides a method of cooking one or more papadums in a microwave oven, comprising:
arranging one or more papadums in a cooking apparatus that supports the papadums in a generally upright orientation between adjacent pairs of dividers;
placing the cooking apparatus in a microwave oven and cooking the papadums for a predetermined period of time.

In a preferred embodiment, at least one ventilation aperture is provided in one or more of the dividers, allowing air to circulate between the papadums during the cooking step.

Preferably, upright spacer members are provided on one or more of the dividers and the papadums are supported in the generally upright orientation by the spacer members.

### BRIEF DESCRIPTION OF THE DRAWINGS

A preferred embodiment of the invention will now be described by way of specific example with reference to the accompanying drawings, in which:

FIG. 1 depicts a microwave cooking apparatus for cooking papadums;

FIG. 2 depicts the cooking apparatus of FIG. 1 with support elements removed;

FIG. 3 is a top view of the cooking apparatus of FIG. 2;

FIG. 4 is an elevation view of the cooking apparatus of FIG. 2;

FIG. 5 is bottom view of the cooking apparatus of FIG. 2; and

FIG. 6 depicts a support element of the cooking apparatus of FIG. 1 in isolation.

### DETAILED DESCRIPTION OF THE PREFERRED EMBODIMENTS

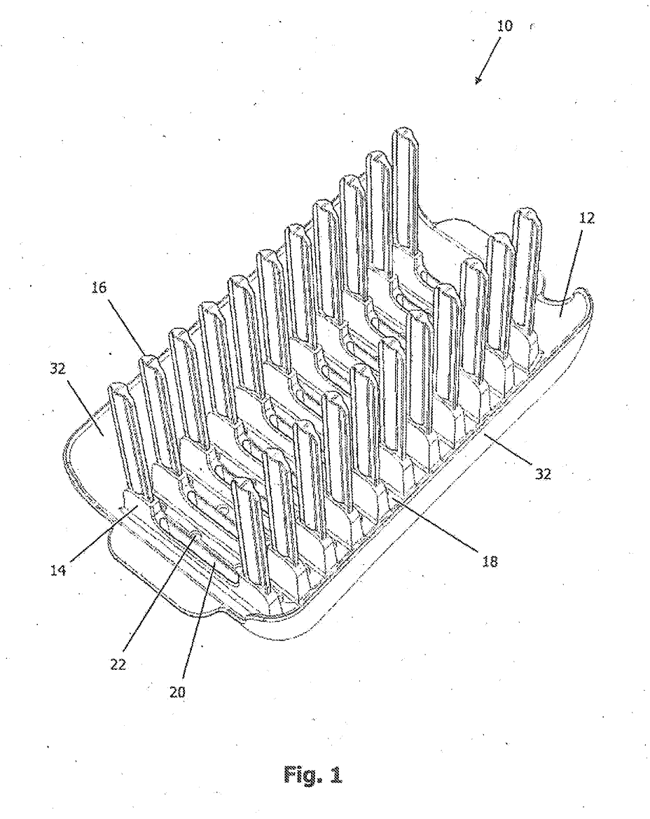

FIG. 1 depicts a microwave cooking apparatus 10 for cooking papadums in a microwave oven. The cooking apparatus 10 has a base 12, eleven dividers 14 and twenty-two spacer members 16. The dividers 14 project in an upright manner from an upper surface 18 of the base 12 and are arranged parallel to one another in a row of eleven. The spacer members 16 project upwardly from the dividers 14, with each divider 14 supporting a pair of parallel spacer members 16 projecting upwardly from opposite ends of the divider 14. Handles 15 are provided for holding or carrying the cooking apparatus 10.

The base 12 is adapted to receive ten uncooked papadums arranged in a generally upright orientation relative to the upper surface 18 of the base 12. The dividers 14 are adapted to receive one papadum between each pair of adjacent dividers 14 in the row. The spacer members 16 are adapted to keep adjacent papadums in the row spaced from one another, with each papadum being maintained in an upright orientation between four of the spacer members 16.

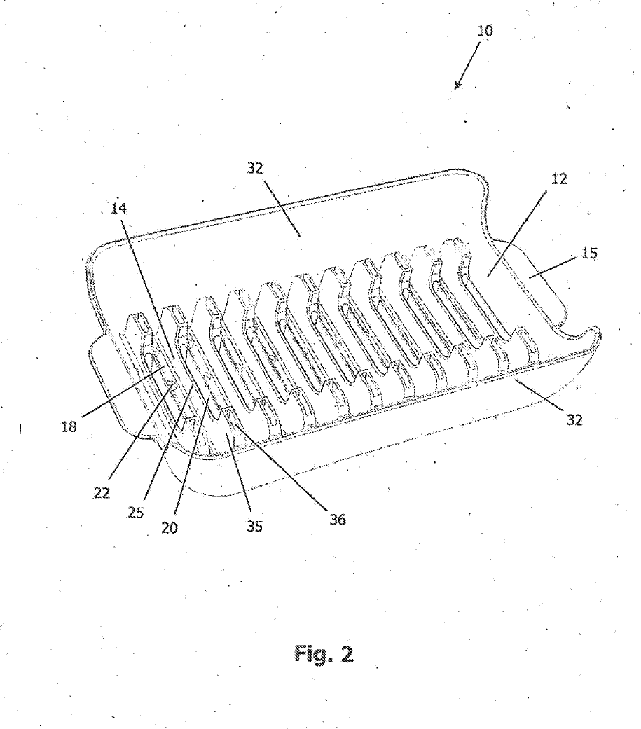

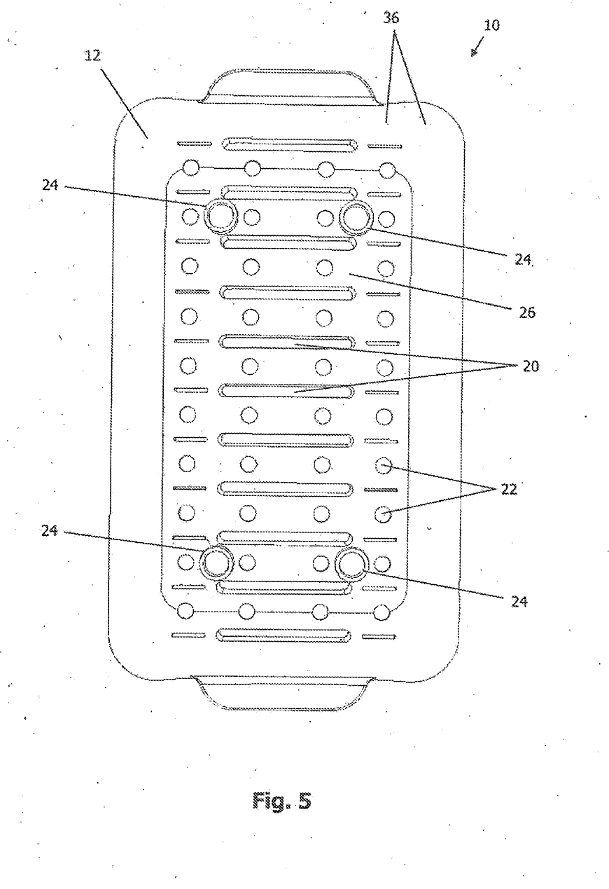

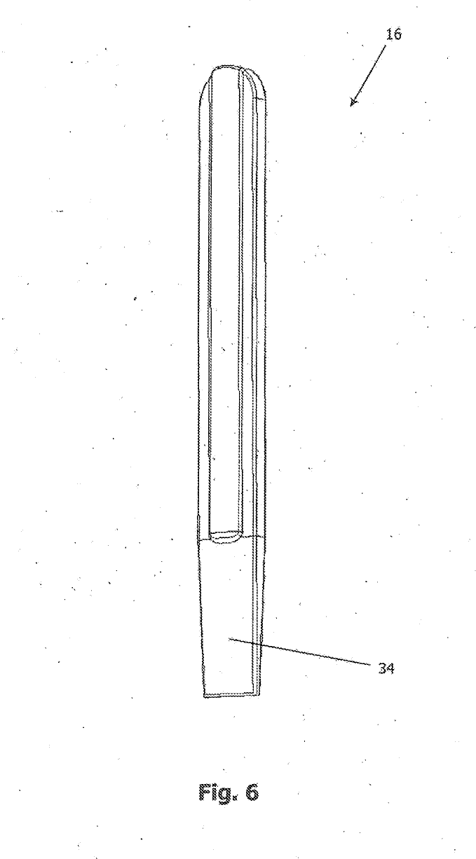

The spacer members 16 are detachable from the dividers 14 for ease of storage and shipping. FIGS. 2 to 5 depict the cooking apparatus 10 from different perspectives with the spacer members 16 removed. FIG. 6 shows a spacer member 16 in isolation.

Ventilation apertures 20, which comprise an elongate slot, are provided in the dividers 14 to facilitate the circulation of air between the papadums. The ventilation apertures 20 are elevated above the upper surface 18 of the base 12 on an upper edge 25 of the dividers 14. Holes 22 are also provided in the base 12 between the dividers 14 to further facilitate air circulation around the papadums. The ventilation apertures 20 and holes 22 allow air to circulate from beneath the base 12, upwards between the papadums. During cooking, air is able to circulate from beneath the base 12 up through the ventilation apertures 20 and holes 22 and between the papadums. This air circulation, which is caused by convection within the microwave oven, provides an improved cooking result.

The base 12 has four support members 24 projecting from a lower surface 26 of the base 12. These support members 24 allow the base 12 to be placed and stand on a support surface 28 so that the lower surface 26 of the base 12 is spaced above the support surface 28. This creates a clearance 30 or air gap between the lower surface 26 of the base 12 and the support surface 28, which allows air to circulate beneath the base 12 and up through the ventilation apertures 20 and holes 22.

As best shown in FIGS. 2 and 4, the base 12 has a pair of opposing edge portions 32 that curl upwardly from the upper surface 18 of the base 12. The edge portions 32 extend along opposite sides of the base 12 creating a generally U-shaped profile that is particularly evident in FIG. 4. The ratio of the height (h) of the edge portions 32 from the upper surface 18 of the base 12 to the total width (w) of the base 12 is preferably in the range of 1:2 to 1:4 and is most preferably approximately 2:5. For papadums that are a similar width to the base 12, this means that the edge portions 32 extend up to somewhere between a quarter of the height and half of the height of the papadums. Ratios in the aforementioned ranges have been found to provide an improved cooking result.

By way of example, one embodiment of the cooking apparatus 10 designed to accommodate a typical papadum diameter of 13.5 cm has a base 12 having a total width of 15 cm and edge portions 32 with a height of 6 cm from the surface of the base 12. In this embodiment, the spacer members 16 extend upwardly about 10 cm from dividers 14 and the dividers 14 extend upwardly approximately 3 cm above the base 12. Accordingly, the spacer elements 16 extend to a height of approximately 13 cm from the base 12, which is slightly shorter than the height of an upright papadum, allowing the papadums to curl slightly at the top during the cooking process for a more authentic effect.

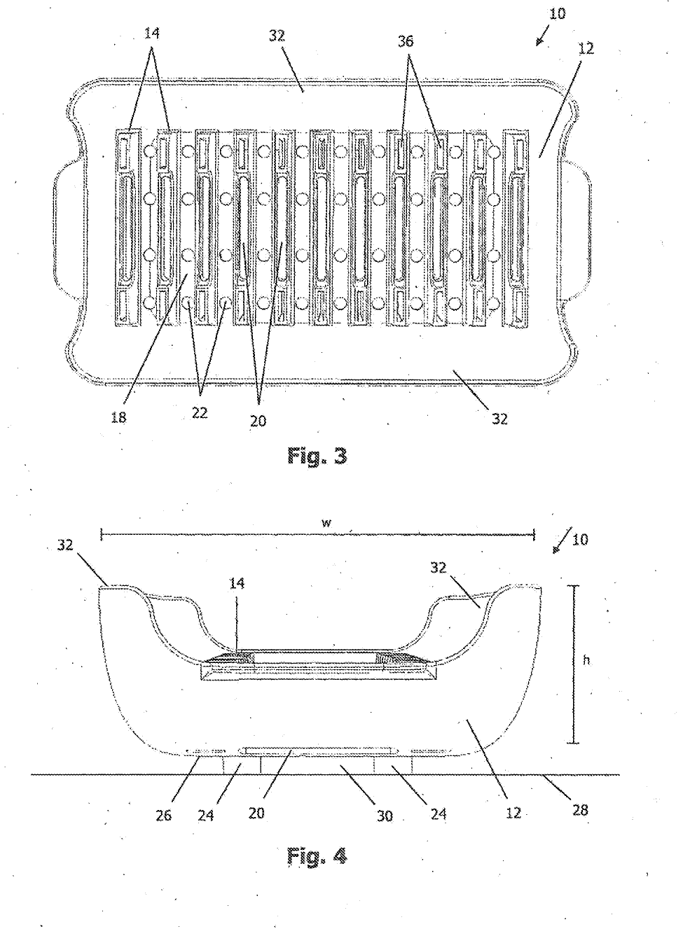

As depicted in isolation in FIG. 6, each spacer member 16 is an elongate member with a wedge shaped tongue portion 34 at one end. The wedge shaped tongue portion 34 of each spacer member 16 is configured to be received in a corresponding slot 36 provided in one of the dividers 14, as best shown in FIGS. 2 and 3. The corresponding slots 36 are provided on a pair of raised portions 35 that project upwardly above the upper edge 25 of the divider 14 at opposite ends of the divider 14.

When the wedge shaped tongue portion 34 of one of the spacer members 16 is inserted into one of the corresponding slots 36, the spacer member 16 is retained in the slot 36 by way of interference fit between the wedge shaped tongue portion 34 and the slot 36.

Assembly is therefore as simple as pressing the wedge shaped tongue portion 34 of one of the spacer members 16 into each of the corresponding slots 36 in the dividers 14. This results in the assembled configuration shown in FIG. 1.

In use, up to ten uncooked papadums are arranged to stand generally vertically (ie. on an edge) in the cooking apparatus 10 with one papadum in between each pair of adjacent dividers 14. The papadums are allowed to rest against one or more of the spacer members 16, which keep the papadums generally upright and separated from one another.

The loaded cooking apparatus 10 is then placed in a microwave oven and cooked on high heat for approximately one and a half to two minutes for a typical 800 W microwave oven.

Convection within the microwave oven circulates air into the clearance 30 beneath the base 12 of the cooking apparatus 10 and upwards through the ventilation apertures 20 and holes 22. This creates a constant movement of air between adjacent papadums and across the surface of each papadum, helping to dry out the papadum during the cooking process. This provides an improved cooking result that is more akin to an authentic fried papadum.

Although the invention has been described with reference to specific examples, it will be appreciated by those skilled in the art that the invention may be embodied in many other forms.

1. A microwave cooking apparatus for cooking papadums in a microwave oven, the cooking apparatus comprising:
a base adapted to receive a plurality of uncooked papadums arranged in a generally upright orientation relative to an upper surface of the base;
a plurality of dividers provided on the upper surface of the base and arranged parallel to one another in a row, the dividers adapted to receive one papadum between each pair of adjacent dividers in the row; and
one or more spacer members projecting from at least one of the dividers, the spacer members being adapted to keep adjacent papadums in the row spaced from one another.

2. The cooking apparatus of claim 1, wherein a ventilation aperture is provided in at least one of the dividers, the ventilation aperture allowing air to circulate between adjacent papadums.

3. The cooking apparatus of claim 2 wherein the ventilation aperture is raised above the upper surface of the base by the divider.

4. The cooking apparatus of claim 2, wherein the base has at least one support member projecting from a lower surface of the base and wherein, when the cooking apparatus is placed on a support surface, the support member is adapted to support the base such that the lower surface of the base is spaced above the support surface, providing a clearance between the base and the support surface.

5. The cooking apparatus of claim 1, wherein holes are provided in the base between the dividers to allow air to circulate from beneath the base.

6. The cooking apparatus of claim 1, wherein the base has a pair of opposing edge portions, the edge portions curling upwardly from the base along opposite sides of the base, creating a generally U-shaped profile.

7. The cooking apparatus of claim 6, wherein a ratio of a height of the edge portions above the base to a total width of the base is in the range 1:2 and 1:4.

8. The cooking apparatus of claim 7 wherein a ratio of a height of the edge portions from the base to a total width of the base is approximately 2:5.

9. The cooking apparatus of claim 1, wherein the base includes a single row of eleven dividers adapted to accommodate ten spaced papadums.

10. The cooking apparatus of claim 1, wherein each divider has a pair of parallel said spacer members extending upwardly from opposite ends of the divider.

11. The cooking apparatus of claim 1, wherein the spacer members are detachable from the dividers.

12. The cooking apparatus of claim 11, wherein the spacer members each have a wedge shaped tongue portion and the dividers have corresponding slots, the tongue portion of each spacer member being configured to be received in the corresponding slot and retained in the slot by way of interference fit between the wedge shaped tongue and the slot.

13. The cooking apparatus of claim 12, wherein a pair of said corresponding slots are provided on a pair of respective raised portions projecting upwardly at opposite ends of one or more of the dividers.

14. A method of cooking one or more papadums in a microwave oven, comprising:
arranging one or more papadums in the cooking apparatus of claim 1 such that the papadums are supported in a generally upright orientation between adjacent pairs of dividers;
placing the cooking apparatus in a microwave oven; and
cooking the papadums for a predetermined period of time.

15. The method of claim 14 wherein at least one ventilation aperture is provided in one or more of the dividers, allowing air to circulate between the papadums during the cooking step.

16. The method of claim 14 wherein upright spacer members are provided on one or more of the dividers and the papadums are supported in the generally upright orientation by the spacer members.

17. The method of claim 15, wherein upright spacer members are provided on one or more of the dividers and the papadums are supported in the generally upright orientation by the spacer members.

18. The cooking apparatus of claim 3, wherein the base has at least one support member projecting from a lower surface of the base and wherein, when the cooking apparatus is placed on a support surface, the support member is adapted to support the base such that the lower surface of the base is spaced above the support surface, providing a clearance between the base and the support surface.
